(19) United States
(12) Patent Application Publication
(10) Pub. No.: US 2026/0366126 A1
(43) Pub. Date: Nov. 19, 2026

(54) METHOD FOR PRODUCING L10-TYPE FeNi ORDERED ALLOY

(71) Applicants: NICHIA CORPORATION, Anan-shi (JP); DENSO CORPORATION, Kariya-city (JP)

(72) Inventors: Takayuki YAMAMOTO, Itano-gun (JP); Haruki FUJISAKI, Anan-shi (JP); Takanori MATSUNO, Anan-shi (JP); Hiroaki KURA, Kariya-city (JP); Eiji WATANABE, Kariya-city (JP); Yoshiaki HAYASHI, Kariya-city (JP)

(73) Assignees: NICHIA CORPORATION, Anan-shi (JP); DENSO CORPORATION, Kariya-city (JP)

(21) Appl. No.: 19/477,431

(22) PCT Filed: Apr. 12, 2024
(86) PCT No.: PCT/JP2024/014806

§ 371 Date: Oct. 21, 2025

(30) Foreign Application Priority Data
Apr. 21, 2023 (JP) 2023-070056

(51) Int. Cl. C22F 1/02; C22C 19/03; C22F 1/10; H01F 1/147

(52) U.S. Cl. CPC C22F 1/02; C22C 19/03; C22F 1/10; H01F 1/14733; C22C 2202/02

(57) ABSTRACT

Provided is a method for more efficiently producing an L1₀-type FeNi ordered alloy with good magnetic properties. The present disclosure relates to a method of producing an L1₀-type FeNi ordered alloy, the method including forming a FeNi alloy to obtain a formed body, nitriding the formed body to obtain a nitride, and denitriding the nitride to obtain an L1₀-type FeNi ordered alloy.

### CROSS-REFERENCE TO RELATED APPLICATIONS

This is a national stage application of PCT Application No. PCT/JP2024/014806, filed on Apr. 12, 2024, which claims priority to Japanese Patent Application No. 2023-070056, filed on Apr. 21, 2023.

### TECHNICAL FIELD

The present disclosure relates to a method of producing an L1₀-type FeNi (iron-nickel) ordered alloy having an L1₀-type ordered structure (hereinafter, also referred to as FeNi superlattice).

### BACKGROUND

FeNi superlattices are expected as magnet materials with high heat resistance or magnetic device materials such as magnetic recording materials. For example, Japanese Patent Publication No. 6332359 discloses a method of producing an L1₀-type FeNi ordered alloy with a high degree of order of at least 0.5. In the disclosed production method, a FeNi superlattice is produced through a nitridation and denitridation process, which includes a nitridation treatment to nitride a FeNi alloy to obtain a nitride, followed by a denitridation treatment to eliminate nitrogen from the nitride.

### SUMMARY

The present inventors have newly discovered that, in the nitridation and denitridation process disclosed in Patent Literature 1, a reverse reaction can occur between the synthesized nitride FeNiN and the simultaneously synthesized hydrogen, resulting in the partial conversion of FeNiN to Fe₂Ni₂N. When such an insufficiently nitrided nitride is denitrided, there is a disadvantage in that an ordered lattice is difficult to form, resulting in degraded magnetic properties.

An object of the present disclosure is to provide a method for more efficiently producing an L1₀-type FeNi ordered alloy with good magnetic properties.

A method of producing a FeNi ordered alloy according to an aspect of the present disclosure relates to a method of producing an L1₀-type FeNi ordered alloy, which includes:
forming a FeNi alloy to obtain a formed body;
nitriding the formed body to obtain a nitride; and
denitriding the nitride to obtain an L1₀-type FeNi ordered alloy.

The present disclosure can provide a method for more efficiently producing an L1₀-type FeNi ordered alloy with good magnetic properties.

### BRIEF DESCRIPTION OF DRAWINGS

FIG. 1A shows a flowchart of a method of producing a FeNi ordered alloy according to an aspect of the present disclosure.

FIG. 1B shows a flowchart of a method of producing a FeNi ordered alloy including a grinding step according to an aspect of the present disclosure.

FIG. 1C shows a flowchart of a method of producing a FeNi ordered alloy including a grinding step and a re-nitridation step according to an aspect of the present disclosure.

FIG. 2 shows a schematic diagram of the lattice structure of an L1₀-type FeNi ordered structure.

### DESCRIPTION OF EMBODIMENTS

Embodiments of the present invention are described in detail below. The following embodiments, however, are intended as examples to give a concrete form to the technical idea of the present invention and are not intended to limit the scope of the present invention to the following embodiments. Moreover, numerical ranges indicated using “to” refer to ranges including the numerical values before and after “to” as the minimum and maximum, respectively. Moreover, parts that are identical or equivalent to each other in the following embodiments are described with the same reference signs.

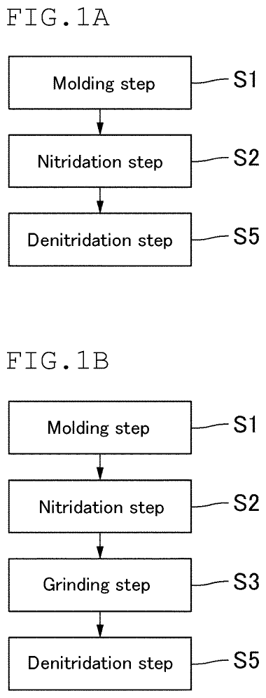

A method of producing an L1₀-type FeNi ordered alloy according to the present embodiment includes:
forming a FeNi alloy to obtain a formed body;
nitriding the formed body to obtain a nitride; and
denitriding the nitride to obtain an L1₀-type FeNi ordered alloy. FIG. 1A shows a flowchart of a method of producing an L1₀-type FeNi ordered alloy according to the present embodiment including a forming step S1, a nitridation step S2, and a denitridation step S5. FIG. 1B shows a flowchart of a method of producing an L1₀-type FeNi ordered alloy according to the present embodiment including a forming step S1, a nitridation step S2, a grinding step S3, and a denitridation step S5. FIG. 1C shows a flowchart of a method of producing an L1₀-type FeNi ordered alloy according to the present embodiment including a forming step S1, a nitridation step S2, a grinding step S3, a re-nitridation step S4, and a denitridation step S5.

The nitridation and denitridation process used in the present embodiment can produce an L1₀-type FeNi ordered alloy through a nitridation step S2 which nitrides a FeNi alloy, and a denitridation step S5 which eliminates nitrogen from the nitride. In the nitridation step S2, FeNiN, a nitride, is synthesized in two stages, starting from FeNi and passing through Fe₂Ni₂N, as shown in the following reaction formulas.

FeNi+½NH₃→Fe₂Ni₂N+¾H₂

Fe₂Ni₂N+½NH₃→FeNiN+¾H₂

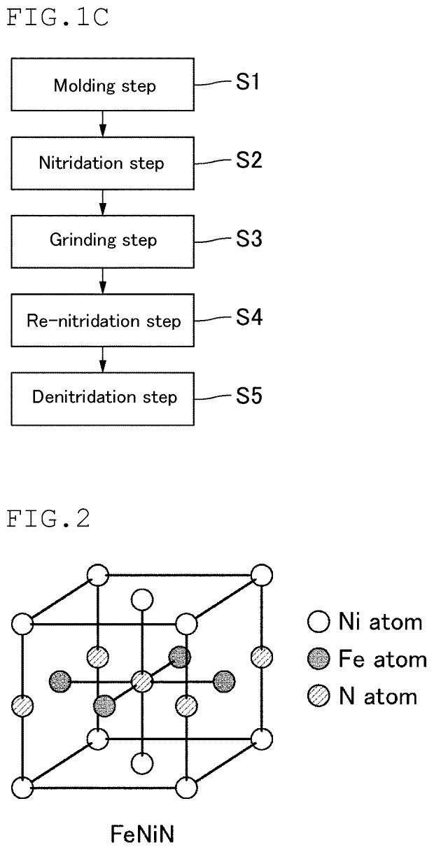

In the nitridation reaction in the second stage, a reverse reaction between the synthesized FeNiN and hydrogen can occur, resulting in the partial conversion of FeNiN to Fe₂Ni₂N. As an ideal ordered alloy, an L1₀-type FeNi ordered alloy with a degree of order S that is 1 can be provided by denitriding FeNiN having an ordered structure in which Fe and Ni layers are alternately arranged as shown in FIG. 2. In contrast, insufficiently nitrided Fe₂Ni₂N does not have an ordered structure in which Fe and Ni layers are alternately arranged. Denitriding such Fe₂Ni₂N cannot provide a regularly ordered FeNi ordered alloy. According to the present embodiment, a FeNi alloy is formed before the nitridation step S2 to reduce the specific surface area of the FeNi alloy. In the nitridation step S2, therefore, the hydrogen-contacting area can be reduced to suppress a reverse reaction between the synthesized FeNiN and hydrogen, thereby achieving high magnetic properties.

### Forming Step S1

The forming step S1 includes forming a FeNi alloy to obtain a formed body. Non-limiting examples of the forming method include rolling with a hand press or a roller compactor.

The FeNi alloy used in the forming step S1 may have an average particle size of, for example, at least 10 nm, preferably at least 50 nm, more preferably at least 100 nm. Moreover, the upper limit of the average particle size may be, for example, not more than 5000 nm, preferably not more than 1000 nm, more preferably not more than 500 nm. The average particle size can be measured by a scanning electron microscopic (SEM) image.

On the other hand, it suffices that the formed body of the FeNi alloy has a specific surface area smaller than the unformed FeNi alloy. For example, it suffices that the formed body of the FeNi alloy has a bulk body formed by forming and has a volume larger than the unformed FeNi alloy powder. The general shape of the formed body of the FeNi alloy may be a spherical, disc, conical, cylindrical, rectangular parallelepiped, polyhedral, or other shape. For example, the formed body of the FeNi alloy in a spherical shape may be truly spherical, but it may also have slight surface irregularities. The formed body in a disc shape may include one in which at least a part of the disc-forming surface has an oval-like shape. To reduce the specific surface area and to promote nitridation, it is preferred to have a shape that allows for a reduction in specific surface area. Thus, a general shape being spherical, disc, rectangular parallelepiped, or polyhedral is more preferred than being cylindrical.

Moreover, it suffices that the formed body of the FeNi alloy has a specific surface area smaller than the unformed FeNi alloy, as described above. The formed body of the FeNi alloy having a rectangular parallelepiped shape is considered to have a long axis, a short axis shorter than the long axis, and a height axis shorter than the short axis. In this case, the length of the long axis may be at least 1 μm but not more than 1 m, preferably at least 10 μm but not more than 100 cm, more preferably at least 50 μm but not more than 50 cm, further preferably at least 100 μm but not more than 10 cm, particularly preferably at least 500 μm but not more than 5 cm. Moreover, the length of the short axis may be at least 0.5 μm but not more than 1 m, preferably at least 5 μm but not more than 50 cm, more preferably at least 20 μm but not more than 50 cm, still more preferably at least 50 μm but not more than 20 cm, particularly preferably at least 200 μm but not more than 5 cm. Moreover, the height axis is shorter than the short axis and preferably has a length of at least 5 μm but not more than 5 cm, more preferably at least 50 μm but not more than 1 cm. When the lengths of the long axis, short axis, and height axis are within the respective ranges described above, the formed body has a constant specific surface area, so that the forming can provide the effect of reducing the reverse reaction; moreover, the formed body has a constant volume, which can promote nitridation. The formed body having a cylindrical shape is considered to be one in which a circle with a long axis and a short axis having the same length has a length in a height axis. It is difficult to uniformly determine the lengths of the long axis, short axis, and height axis of the formed body having a spherical or polyhedral shape, but these shapes preferably have surface areas and volumes close to those of the above-described shapes.

The FeNi alloy used in the forming step S1 may form a disordered structure. Here, the disordered structure may be a random structure in which atoms are arranged in a disordered manner, or a structure that shows no peak corresponding to an L1₀-type ordered structure when measured by X-ray diffraction.

The ratio of the number of moles of Fe to the total number of moles of Fe and Ni in the FeNi used in the forming step S1 may be at least 0.4 but not greater than 0.6, preferably at least 0.45 but not greater than 0.55, more preferably at least 0.48 but not greater than 0.52.

For example, the FeNi alloy used in the forming step S1 can be provided by reducing a FeNi oxide.

### Reduction Step

The reduction step may be carried out by any reduction method, for example, heat treating a FeNi oxide in a reducing gas atmosphere. The flow rate of the reducing gas per 8.5 g of the FeNi oxide may be at least 0.1 L/min but not greater than 15.0 L/min, preferably 0.5 to 10.0 L/min. The heat treatment temperature may be, for example, at least 300 °C but not higher than 700 °C, preferably at least 450 °C but not higher than 700 °C. The duration of heat treatment may be, for example, at least 0.5 hours but not longer than 10 hours, preferably at least 1.0 hours but not longer than 5 hours. Examples of the reducing gas include hydrogen and carbon monoxide. Hydrogen is preferred in terms of reducibility.

The ratio of the number of moles of Fe to the total number of moles of Fe and Ni in the FeNi oxide may be at least 0.4 but not greater than 0.6, preferably at least 0.45 but not greater than 0.55, more preferably at least 0.48 but not greater than 0.52.

The FeNi oxide used in the reduction step may contain a Fe oxide, a Ni oxide, or an oxide containing Fe and Ni. Here, the term “oxide containing Fe and Ni” means that one oxide particle contains Fe and Ni elements.

Non-limiting examples of the Fe oxide include FeO, Fe₂O₃, and Fe₃O₄, as well as oxides obtained by oxidizing iron metal, iron hydroxide, iron carbonate, iron chloride, iron iodide, iron bromide, iron sulfate, iron nitrate, iron phosphate, iron oxalate, or other raw materials.

Non-limiting examples of the Ni oxide include NiO, as well as oxides obtained by oxidizing nickel metal, nickel hydroxide, nickel carbonate, nickel chloride, nickel iodide, nickel bromide, nickel sulfate, nickel nitrate, nickel phosphate, nickel oxalate, or other raw materials.

The oxide containing Fe and Ni used in the reduction step can be produced by mixing a solution containing Fe and Ni with a precipitant to obtain a precipitate containing Fe and Ni (precipitation step) and heat treating the precipitate to obtain an oxide containing Fe and Ni (oxidation step). This method facilitates the control of the average particle size or particle size distribution of the oxide containing Fe and Ni to be obtained, and also provides a more uniform distribution of Fe and Ni elements in the oxide containing Fe and Ni.

### Precipitation Step

The precipitation step includes dissolving a Fe raw material and a Ni raw material in a strongly acidic solution to provide a solution containing Fe and Ni.

The Fe raw material and the Ni raw material may be any materials that can dissolve in an acidic solution. Examples of the Fe raw material include iron metal, iron oxide, iron hydroxide, iron carbonate, iron chloride, iron iodide, iron sulfate, iron nitrate, iron phosphate, and iron oxalate. Among these, iron metal, iron carbonate, iron sulfate, and iron chloride are preferred. Examples of the Ni raw material include nickel metal, nickel oxide, nickel hydroxide, nickel carbonate, nickel chloride, nickel iodide, nickel sulfate, nickel nitrate, nickel phosphate, and nickel oxalate. Among these, nickel metal, nickel carbonate, nickel sulfate, and nickel chloride are preferred. Examples of the acidic solution include sulfuric acid, nitric acid, hydrochloric acid, and phosphoric acid. The concentration of the solution containing Fe and Ni may be appropriately adjusted within a range in which the Fe raw material and the Ni raw material substantially dissolve in the acidic solution.

The ratio of the number of moles of Fe to the total number of moles of Fe and Ni in the solution containing Fe and Ni may be at least 0.4 but not greater than 0.6, preferably 0.45 to 0.55, more preferably 0.48 to 0.52.

The solution containing Fe and Ni is reacted with a precipitant to obtain a precipitate containing Fe and Ni. The reaction between the solution containing Fe and Ni and the precipitant may be carried out by introducing the precipitant into the solution containing Fe and Ni or introducing the solution containing Fe and Ni into the precipitant. Here, it suffices that the solution containing Fe and Ni contains Fe and Ni upon the reaction with the precipitant. Raw materials containing Fe and Ni may be prepared as separate solutions, each of which may be introduced and reacted with the precipitant. The separate solutions are also appropriately prepared such that each raw material substantially dissolves in the acidic solution. The precipitant may be any precipitant that can react with the solution containing Fe and Ni to give a precipitate. Examples include oxalic acid and alkaline solutions such as an aqueous sodium hydroxide solution, an aqueous sodium bicarbonate solution, an aqueous potassium hydroxide solution, and an aqueous lithium hydroxide solution. A precipitate can also be obtained by injecting carbon dioxide gas into the solution containing Fe and Ni. The precipitate to be synthesized may be an oxalate, a carbonate, a hydroxide, or another compound.

The precipitation step may include separating and washing the precipitate. For example, the precipitate may be separated by adding a solvent, preferably water, to the obtained precipitate, mixing them, and then subjecting the mixture to filtration, decantation, or other separation processes. Moreover, the washing may be carried out by subjecting the precipitate, once separated, to repeated washing in the same manner.

After separating the precipitate, the separated precipitate is preferably desolvated to reduce aggregation of the precipitate caused by evaporation of the residual solvent in which the precipitate has been re-dissolved during the heat treatment in the subsequent oxidation step. Specifically, when the solvent used is water, for example, the desolvation may be carried out by drying in an oven at a temperature of at least 70 °C but not higher than 200 °C for at least 5 hours but not longer than 12 hours. Moreover, the drying may optionally be followed by particle size adjustment through crushing or grinding.

### Oxidation Step

The oxidation step includes heat treating the precipitate containing Fe and Ni obtained in the precipitation step to obtain an oxide containing Fe and Ni. For example, the oxidation step can convert the precipitate to an oxide by heat treatment. The heat treatment of the precipitate needs to be performed in the presence of oxygen, for example, in the air atmosphere. Moreover, because the presence of oxygen is necessary, the non-metal part of the precipitate preferably contains oxygen atoms. The use of the precipitate containing Fe and Ni in the oxidation step can provide a FeNi oxide. Moreover, the obtained FeNi oxide may optionally be subjected to particle size adjustment through crushing or grinding.

The heat treatment temperature in the oxidation step (hereinafter, oxidation temperature) is not limited and may be, for example, at least 200 °C but not higher than 800 °C, preferably 350 to 450 °C. The duration of heat treatment may be, for example, at least 4 hours but not longer than 24 hours, preferably at least 4 hours but not longer than 12 hours.

The obtained oxide corresponds to oxide particles in which Fe and Ni have been sufficiently microscopically mixed, and the particle shape, particle size distribution, and other properties of the precipitate have been reflected.

### Nitridation Step S2

The nitridation step S2 includes nitriding the FeNi formed body obtained in the forming step S1 to obtain a nitride containing Fe and Ni (hereinafter, nitride). The nitridation may be any nitridation that can produce a nitride from the FeNi alloy, and may include contact with a nitrogen-containing compound such as gas nitridation with ammonia gas or nitrogen, plasma nitridation, or nitridation with a metal amide. Specifically, the nitridation can be carried out by subjecting the FeNi provided in advance to heat treatment under a flow of a nitrogen-containing compound such as ammonia gas. The flow rate of the nitrogen-containing compound per gram of FeNi may be at least 0.1 L/min but not greater than 10 L/min, preferably in a range of 0.5 to 5 L/min. The heat treatment temperature may be, for example, at least 300 °C but not higher than 500 °C, preferably in a range of 310 °C to 475 °C, more preferably in a range of 330 °C to 450 °C. The duration of heat treatment may be, for example, at least 5 hours but not longer than 50 hours, preferably at least 10 hours but not longer than 20 hours.

The nitride obtained in the nitridation step S2 may be FeNiN, Fe₂Ni₂N, or another nitride. The percentage of FeNiN is preferably high to obtain an L1₀-type FeNi ordered alloy. FeNiN has a crystal structure as illustrated in FIG. 2 and can be identified from the XRD diffraction pattern. The percentage of the FeNi nitride such as FeNiN or Fe₂Ni₂N contained after the nitridation step S2 may be at least 90% by mass of the total nitride. Moreover, the percentage of FeNiN in the nitride may be at least 50% by mass, preferably at least 80% by mass. The percentages of the nitride and FeNiN after the nitridation step S2 can be calculated by analyzing the XRD diffraction pattern using the reference intensity ratio (RIR) method.

The nitrogen content of the nitride obtained by nitridation may be at least 9.5% by mass but not greater than 11.5% by mass, preferably at least 9.6% by mass but not greater than 11.3% by mass, more preferably at least 9.8% by mass but not greater than 11.2% by mass. When the nitride only contains FeNiN due to the promotion of nitridation, the nitride has a nitrogen content of about 10.9%. A nitrogen content closer to this value is considered to lead to more nitridation. Moreover, the nitrogen content of the nitride can be measured by the inert gas fusion-thermal conductivity method. The inert gas fusion-thermal conductivity method has an error of less than 0.3% by mass.

### Denitridation Step S5

The denitridation step S5 includes denitriding the FeNi nitride obtained in the above-described nitridation step S2 to obtain an L1₀-type FeNi ordered alloy. Specifically, the FeNi nitride obtained in the nitridation step S2 can be denitrided by heat treating it in hydrogen atmosphere. The flow rate of hydrogen per gram of the FeNi nitride in the denitridation may be at least 0.01 L/min but not greater than 10 L/min, preferably at least 0.1 L/min but not greater than 5 L/min. The heat treatment temperature may be, for example, at least 100 °C but not higher than 450 °C. The lower limit of the heat treatment temperature is preferably at least 200 °C, more preferably at least 220 °C. The upper limit of the heat treatment temperature is preferably not higher than 400 °C, more preferably not higher than 350 °C. The duration of heat treatment may be, for example, at least 1 hour but not longer than 24 hours, preferably 4 to 18 hours.

In the case of the L1₀-type FeNi ordered alloy containing sulfur, the sulfur content is preferably not greater than 2.0% by mass, more preferably not greater than 1.5% by mass. Moreover, the lower limit of the sulfur content may be 0.01% by mass, preferably at least 0.03% by mass.

### Grinding Step S3

The nitridation step S2 is preferably followed by a grinding step S3 which includes grinding the nitride to obtain a ground nitride. FIG. 1B shows a flowchart according to this aspect. The grinding step S3 includes refining the polycrystals of the nitride to be close to single magnetic domain particles. The grinding may be carried out by any means, such as a planetary mill, a jet mill, a ball mill, a roller mill, or a pin mill. When the grinding is carried out using a planetary mill, the diameter of the beads used may be at least 0.1 mm but not more than 3 mm, preferably at least 0.3 mm but not more than 1 mm. The rotation speed may be, for example, at least 10 rpm but not more than 30000 rpm, at least 30 rpm but not more than 10000 rpm, or at least 100 rpm but not more than 5000 rpm. The duration of grinding may be at least 5 minutes but not longer than 180 minutes, preferably at least 15 minutes but not longer than 60 minutes.

### Re-Nitridation Step S4

The grinding step S3 is preferably followed by a re-nitridation step S4 which includes re-nitriding the ground nitride to obtain a re-nitrided nitride. FIG. 1C shows a flowchart according to this aspect. Although the grinding may reduce the percentage of ordered structures and thus degrade the magnetic properties, the re-nitridation step S4 can increase the percentage of ordered structures again, thereby suppressing the degradation of the magnetic properties. The re-nitridation step S4 can be performed in the same or similar manner as the nitridation step S2.

The nitrogen content of the re-nitrided nitride may be at least 10.2% by mass but not greater than 11.5% by mass, preferably at least 10.8% by mass but not greater than 11.2% by mass, though not limited thereto.

The L1₀-type FeNi ordered alloy obtained by the production method according to the present embodiment has an L1₀-type ordered structure. Here, the term “L1₀-type ordered alloy” means that the degree of order is at least 0.1. The degree of order may preferably be at least 0.5. Moreover, the upper limit of the degree of order may be not more than 1. Here, the term “degree of order S” indicates the degree of order of the FeNi superlattice. The L1₀-type ordered structure is based on a face-centered cubic lattice and has a lattice structure as shown in FIG. 2. In the drawing, the uppermost layer in a stacking structure on the (001) plane of the face-centered cubic lattice is defined as site I, and the middle layer located between the uppermost and lowermost layers is defined as site II. In this case, if the ratio of metal A present at site I is defined as x, and the ratio of metal B present at site I is defined as 1−x, then the ratio of metal A and metal B present at site I is expressed as AxB1−x. Similarly, if the ratio of metal B present at site II is defined as x, and the ratio of metal A present at site II is defined as 1−x, then the ratio of metal A and metal B present at site II is expressed as A1−xBx. Here, x satisfies the relationship: 0.5≤x≤1. In this case, the degree of order S is then defined as S=2x−1.

In the case of the L1₀-type FeNi ordered alloy consisting of particles having an L1₀-type ordered structure, the lower limit of the average particle size may be, for example, at least 10 nm, preferably at least 50 nm, more preferably at least 100 nm. Moreover, the upper limit of the average particle size may be, for example, not more than 5000 nm, preferably not more than 1000 nm, more preferably not more than 500 nm. The average particle size can be measured by a scanning electron microscopic (SEM) image.

The L1₀-type FeNi ordered alloy may consist of secondary particles obtained by aggregation of primary particles. In this case, the lower limit of the average particle size of the primary particles may be, for example, at least 10 nm, preferably at least 30 nm, more preferably at least 50 nm. Moreover, the upper limit of the average particle size of the primary particles may be, for example, not more than 1000 nm, preferably not more than 500 nm. The average particle size of the primary particles can be calculated by analyzing an XRD pattern using the Williamson-Hall method.

The ratio of the number of moles of Fe to the total number of moles of Fe and Ni in the L1₀-type FeNi ordered alloy may be 0.4 to 0.6, preferably 0.45 to 0.55, more preferably 0.48 to 0.52. The numbers of moles of Fe and Ni can be measured using techniques such as inductively coupled plasma (ICP)-atomic emission spectroscopy or energy dispersive X-ray spectroscopy (EDS) with an electron microscope.

### EXAMPLES

The present disclosure is more specifically described below with reference to, but not limited to, working examples and other examples.

### Production Example 1

An oxalate containing Fe and Ni with a molar ratio of 1:1 and also containing S was obtained by co-precipitation with a sulfate.

### Oxidation Step

An amount of 50 g of the obtained oxalate containing Fe, Ni, and S was heat treated at 400 °C in the air for eight hours and then cooled to obtain an oxide containing Fe, Ni, and S.

### Reduction Step

An amount of 8.5 g of the oxide containing Fe, Ni, and S was heat treated at 450 °C in hydrogen gas atmosphere (hydrogen flow rate 1 L/min) for 1.5 hours and then cooled to obtain a FeNi alloy containing S. The alloy had a sulfur content of 0.03% by mass. Here, the sulfur content was measured by ICP-AES analysis (device name: Optima 8300) of a solution of the alloy in hydrochloric acid, and was defined as the ratio of the weight of S to the total weight of Fe, Ni, and S.

### Example 1

### Forming Step S1

A molding die with a cavity measuring 2 cm in diameter and 4 cm in height, with a lower punch attached thereto, was charged with 2 g of the FeNi alloy obtained in Production Example 1. Subsequently, an upper punch was attached to the molding die, followed by compression at a pressure of 1 ton/cm² for one minute using a hydraulic press. Thus, a disc-shaped formed body having a weight of 2 g, a diameter of 2 cm, and a thickness of 2 mm was obtained.

### Nitridation Step S2

An amount of 2 g of the formed body obtained in the forming step S1 was heat treated at 415 °C in ammonia gas atmosphere (ammonia flow rate 1 L/min) for 60 hours to obtain a nitride. The nitrogen content in the nitride was 10.9% by mass.

### Grinding Step S3

An amount of 1 g of the nitride obtained in the nitridation step S2 and 60 g of stainless steel balls with a diameter of 1 mm were supplied into a high-hardness stainless steel container. Grinding was performed using a planetary mill at 600 rpm for 30 minutes to obtain a ground nitride.

### Re-Nitridation Step S4

The ground nitride obtained in the grinding step S3 was heat treated at 400 °C in ammonia gas atmosphere (ammonia flow rate 1 L/min) for 10 hours to obtain a re-nitrided nitride.

### Denitridation Step S5

The nitride obtained in the re-nitridation step S4 was heat treated at 250 °C in hydrogen gas atmosphere (hydrogen flow rate 1 L/min) for 15 hours to obtain an L1₀-type FeNi ordered alloy. Here, the L1₀-type ordered alloy had a sulfur content of 0.03% by mass. The sulfur content was confirmed to be almost the same as the sulfur content of the FeNi alloy containing S obtained in the reduction step. Here, the sulfur content was measured by ICP-AES analysis of a solution of the obtained FeNi alloy in hydrochloric acid, and was defined as the ratio of the weight of S to the total weight of Fe, Ni, and S.

### Example 2

An L1₀-type FeNi ordered alloy of Example 2 was obtained as in Example 1, except that the grinding step S3 and the re-nitridation step S4 were not performed.

### Example 3

An L1₀-type FeNi ordered alloy of Example 3 was obtained as in Example 1, except that the re-nitridation step S4 was not performed and the denitridation step S5 was performed at 200 °C for five hours.

### Example 4

An L1₀-type FeNi ordered alloy of Example 4 was obtained as in Example 1, except that the grinding step S3 was performed at 600 rpm for 60 minutes and the denitridation step S5 was performed at 250 °C for five hours.

### Example 5

An L1₀-type FeNi ordered alloy of Example 5 was obtained as in Example 1, except that the grinding step S3 was performed at 600 rpm for five minutes.

### Example 6

An L1₀-type FeNi ordered alloy of Example 6 was obtained as in Example 1, except that the grinding step S3 was performed at 600 rpm for 15 minutes, the re-nitridation step S4 was performed at 400 °C for three hours, and the denitridation step S5 was performed at 250 °C for five hours.

### Comparative Example 1

An L1₀-type FeNi ordered alloy of Comparative Example 1 was obtained as in Example 1, except that the forming step S1, the grinding step S3, and the re-nitridation step S4 were not performed.

The magnetic properties of the FeNi ordered alloys provided in the examples and comparative example were evaluated as described below. Table 1 shows the results together with the production conditions. The N content of the FeNi ordered alloys provided in Examples 1 and 5 and Comparative Example 1 was also measured as described below. Table 2 shows the results.

### Coercivity and Saturation Magnetization

The magnetic particles obtained in each example were packed into a sample vessel together with paraffin wax. After the paraffin wax was melted with a dryer, the easy axes of magnetization were aligned in an orientation field of 16 kA/m. The magnetically oriented sample was pulse magnetized in a magnetizing field of 32 kA/m, and the coercivity (kA/m) and the saturation magnetization (Am²/kg) were measured using a vibrating sample magnetometer (VSM) with a maximum field of 16 kA/m. The coercivity and saturation magnetization of the ordered alloy of Comparative Example 1 were each set to 1.0 to calculate relative values.

### Nitrogen Content

The nitrogen content of the magnetic particles obtained in Examples 1 and 5 and Comparative Example 1 were measured by the inert gas fusion-thermal conductivity method (EMGA-820 available from HORIBA, Ltd.).

TABLE 1

| | | | | | | VSM measurement results after | |
|---|---|---|---|---|---|---|---|
| | | | | Re-nitridation | Denitridation | denitridation | |
| | Molding | Nitridation | Grinding step | step | step | Relative | Relative saturation |
| Example No. | step | step | Conditions | Conditions | Conditions | coercivity | magnetization |
| Comparative | Not | Performed | Not performed | Not performed | 250 °C, 15 hours | 1.0 | 1.0 |
| Example 1 | performed | | | | | | |
| Example 1 | Performed | Performed | 30 minutes | 10 hours | 250 °C, 15 hours | 5.1 | 8.0 |
| Example 2 | Performed | Performed | Not performed | Not performed | 250 °C, 15 hours | 1.2 | 2.4 |
| Example 3 | Performed | Performed | 30 minutes | Not performed | 200 °C, 5 hours | 1.9 | 7.4 |
| Example 4 | Performed | Performed | 60 minutes | 10 hours | 250 °C, 5 hours | 5.2 | 8.1 |
| Example 5 | Performed | Performed | 5 minutes | 10 hours | 250 °C, 15 hours | 5.0 | 7.2 |
| Example 6 | Performed | Performed | 15 minutes | 3 hours | 250 °C, 5 hours | 5.0 | 7.1 |

TABLE 2

| | Nitrogen content | | |
|---|---|---|---|
| | After | After | After |
| Example No. | nitridation step | grinding step | re-nitridation step |
| Comparative | 9.16 | — | — |
| Example 1 | | | |
| Example 1 | 10.09 | 9.56 | 11.12 |
| Example 5 | 10.02 | 9.53 | 11.15 |

The FeNi ordered alloy of Comparative Example 1, in which no forming step S1 was performed, had both low coercivity and low saturation magnetization. In contrast, both magnetic properties were improved in Example 2, in which the forming step S1 was performed. Moreover, the magnetic properties were further improved in Example 3, in which the grinding step S3 was performed, and Examples 1 and 4 to 6, in which the grinding step S3 and the re-nitridation step S4 were performed.

1. A method of producing an L1₀-type FeNi ordered alloy, the method comprising:
forming a FeNi alloy to obtain a formed body;
nitriding the formed body to obtain a nitride; and
denitriding the nitride to obtain an L1₀-type FeNi ordered alloy.

2. The method of producing an L1₀-type FeNi ordered alloy according to claim 1,
wherein the nitriding is followed by grinding the nitride to obtain a ground nitride, and
the grinding is followed by the denitriding comprising denitriding the ground nitride.

3. The method of producing an L1₀-type FeNi ordered alloy according to claim 2,
wherein the grinding is followed by re-nitriding the ground nitride to obtain a re-nitrided nitride, and
the re-nitriding is followed by the denitriding comprising denitriding the re-nitrided nitride.

4. The method of producing an L1₀-type FeNi ordered alloy according to claim 1,
wherein the nitriding comprises nitriding the formed body at a temperature in a range of at least 300 °C but not higher than 500 °C.

5. The method of producing an L1₀-type FeNi ordered alloy according to claim 4,
wherein the nitriding comprises nitriding the formed body at a temperature in a range of at least 330 °C but not higher than 450 °C.

6. The method of producing an L1₀-type FeNi ordered alloy according to claim 1,
wherein the nitriding comprises contacting the formed body with a nitrogen-containing compound.

7. The method of producing an L1₀-type FeNi ordered alloy according to claim 1,
wherein the denitriding comprises denitriding the nitride at a temperature in a range of at least 100 °C but not higher than 450 °C.

8. The method of producing an L1₀-type FeNi ordered alloy according to claim 2,
wherein the nitriding comprises nitriding the formed body at a temperature in a range of at least 300 °C but not higher than 500 °C.

9. The method of producing an L1₀-type FeNi ordered alloy according to claim 8,
wherein the nitriding comprises nitriding the formed body at a temperature in a range of at least 330 °C but not higher than 450 °C.

10. The method of producing an L1₀-type FeNi ordered alloy according to claim 2,
wherein the nitriding comprises contacting the formed body with a nitrogen-containing compound.

11. The method of producing an L1₀-type FeNi ordered alloy according to claim 2,
wherein the denitriding comprises denitriding the nitride at a temperature in a range of at least 100 °C but not higher than 450 °C.

12. The method of producing an L1₀-type FeNi ordered alloy according to claim,
wherein the nitriding comprises nitriding the formed body at a temperature in a range of at least 300 °C but not higher than 500 °C.

13. The method of producing an L1₀-type FeNi ordered alloy according to claim 12,
wherein the nitriding comprises nitriding the formed body at a temperature in a range of at least 330 °C but not higher than 450 °C.

14. The method of producing an L1₀-type FeNi ordered alloy according to claim 3,
wherein the nitriding comprises contacting the formed body with a nitrogen-containing compound.

15. The method of producing an L1₀-type FeNi ordered alloy according to claim 3,
wherein the denitriding comprises denitriding the nitride at a temperature in a range of at least 100 °C but not higher than 450 °C.
